(19) United States
(12) Patent Application Publication
(10) Pub. No.: US 2004/0223645 A1
(43) Pub. Date: Nov. 11, 2004

(54) Generation of documents

(75) Inventor: David Trevor Cliff, Southville (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/840,330

(22) Filed: May 7, 2004

(30) Foreign Application Priority Data
May 10, 2003 (GB) 0310765.3

(51) Int. Cl. G06K 9/34

(52) U.S. Cl. 382/186

(57) ABSTRACT

A method of generating a document using a processing apparatus (112) such that the text thereof is intended to look like hand writing, wherein the method comprises providing characters (600), having one or more parameters associated therewith, such that at least one occurrence of any one character (600) has at least one parameter (which may be the shape of the character) varied between at least some occurrences of that character (600) by the processing apparatus (112) such that the appearance of any one character (600) is different from at least some other occurrences of that character. In other embodiments the characters need not look like hand writing and variations between characters may be recorded in order to increase the security of a document.

### TECHNICAL FIELD OF THE INVENTION

This invention relates to a method and associated apparatus for improving the security of a document. It also relates to a method and associated apparatus for generating documents using characters that resemble hand writing.

### BACKGROUND OF THE INVENTION

Modern word processing programs provide a user with a great deal of freedom in the font that is used for creating documents allowing the user to display a document on screen as it is intended to be printed. Such technologies may include proportional spacing, which varies the spacing between letters so that the document looks better when printed. Fonts are known, such as the example shown in FIG. 1, which are designed to mimic handwriting. A user that wishes to write a document that is perhaps less formal can therefore select such a font. However, such fonts, although indeed less formal, do not really resemble handwriting.

### SUMMARY OF THE INVENTION

According to a first aspect of the invention there is provided a method of using a processing apparatus to generate a document the text of which is intended to look like handwriting, the method comprising providing a font based upon a typeface, the font allowing a user to alter the appearance of the typeface and being held in a memory accessible by the processing apparatus, the typeface being constituted by a plurality of characters, and the method further comprising causing the processing apparatus to select an example of a character from the typeface as a character is required for the document such that the selected character has the shape thereof varied when compared to at least one other occurrence of that character used elsewhere in the document.

An advantage of such a method is that it can allow documents to be generated that look more like handwriting. Often, it can be quicker for a person to type a letter than it is for him/her to handwrite a letter. Therefore, use of the method may be advantageous because it may increase the speed at which a document can be generated therefore saving the user time in generating the document.

According to a second aspect of the invention there is provided a computer system comprising a processing means and a memory, said processing means being programmed to generate a document the text of which is intended to look like hand writing and the memory being arranged to store a font based upon a typeface, the font allowing a user to alter the appearance of the typeface and the type face being constituted by a plurality of characters the processing means being further arranged to access said memory and select an example of a character from the typeface as a character is required for the document and further arranged to vary the shape of any one character between occurrences of at least some of that character.

According to a third aspect of the invention there is provided a method of increasing the security of a document comprising generating the document such that at least one character used therein has the shape thereof varied when compared to at least one other occurrence of that character elsewhere in the document and the method further comprising recording the variation of the shape of the or each character such that the identity of the document can be verified using the recorded variation of the shape of the or each character.

Such a method may be used to “fingerprint” a document so that its origins may determined at a later time by reviewing the variations of characters therein with the variations that have been recorded for that document.

The method may include the step of varying the, or each, parameter of at least one character each time the document is generated; or perhaps varying it for each person that generates the document; or may be each time the document is generated from a different printer/computer; for each intended and/or actual recipient of the document; or other similar situation. The term generation may include any one or more of the following (this list is not intended to be exhaustive): any creation of a physical document (including printing); creation of an electronic document; creation of a document by editing an existing document. Such arrangements are convenient because they may allow each version of the document to be traced; each document printed, or otherwise generated could be arranged to have a unique fingerprint. This may help to trace the identity of people leaking documents and/or the location from which a document originated by identifying the fingerprint of a leaked document and then determining from where or from whom the document originated.

According to a fourth aspect of the invention there is provided a computer system comprising a processing means, a storage means capable of allowing the processing means to store data therein and a reproduction means connected to and controllable by said processing means said processing means being programmed to cause said reproduction means to reproduce a document using characters, such that at least one character used therein has the shape thereof varied when compared to at least one other occurrence of that character elsewhere in the document, and being further programmed to record data within the storage means recording the variation of the shape of the or each character such that the identity of the document can be verified using the recorded variation of the shape of the or each character.

Such a computer system is advantageous since it may allow documents to be printed, or otherwise reproduced, which have differing arrangements of the characters within the document that is stored within the storage means. This differing arrangement of characters may be useful in determining the origin of the document. For example the processing means may be programmed to vary the parameter each time the document is printed/reproduced; for each different user; according to the identity of the system which caused the document to be printed/reproduced, for each intended and/or actual recipient of the document; on any other suitable basis. Reproduced may include the generation of an electronic version of the document.

According to a fifth aspect of the invention there is provided a business method of generating a font based upon a person's hand writing and selling that font so that documents can be generated such that the generated document is perceived to have been written in the handwriting of the person on whose handwriting the font is based.

The method may include a step of adding at least one known difference such that the generated font is made more discernible from the person's hand writing upon which the generated font is based. Such a step is advantageous because it may prevent documents generated by the method from becoming too similar so that they can be passed off as original.

According to a sixth aspect of the invention there is provided a method of machine generating a document containing one or more characters which are intended to look like hand writing comprising analysing a portion of a person's hand writing, held in a machine readable format, in order to identify traits within characters of that hand writing, and using the identified traits to generate a typeface constituted by a one or more characters for said machine generated document.

An advantage of such a method is that it may make each character of the machine generated portion of text different one another since the characters are being generated according to the identified traits and are not being selected from a predetermined range of characters as is the case with the prior art.

The machine readable format may be a bitmap, or the like, and may be created by any suitable method.

Various mechanisms may be used to generate the font and/or identify the traits within the characters and these may include any one or more of the following: vectorising the machine readable format (via the use of any vectorisation method known in the prior art, such as the “Silhouette” vectorisation software produced by FreeSoft™ S.A. of Belgium http://www.silhouetteonline.com/, or vectorisation via “active contour” techniques leading to point-distribution models such as those reviewed in C. Freeburn “Exploration of Point Distribution Models in Machine Vision” HPLabs Technical Report serial number HPL-2000-14; available from http://lib.hpl.hp.com/techpubs/2000/HPL-2000-14.html).

The method may build a statistical model of the hand writing and use this model to generate characters for the machine generated document.

The following optional methods may be used with any one or more of the methods of the first, third, fifth, sixth aspects of the invention.

The shape of a character may be varied by altering one or more of the following the dimensions of any one example of a character relative to other examples of that character; the position of the character relative to other examples of that character; the shape of the character; the width of the line used to represent the character; variations in the relative spacing and arrangement and dimensions of components (e.g. strokes/vectors) of the characters, and the partial or complete absence of such components, so long as such variations are consistent with whatever statistical model of the font has been constructed.

Conveniently, the method comprises providing a number of examples of any one character within the typeface and selecting characters from the examples in order to provide a character. The method may alternatively, or additionally, comprise altering the shape of one or more examples of a character and/or generating an example of a character each time that example of a character is required. It will be appreciated that hand written script is not uniform, and that therefore, providing a method that allows the shape of a character to be varied between occurrences of that character is advantageous because it can make the font look more like hand written text.

The method may comprise scanning a portion of an original document, which would generally be hand written, to produce a scanned image and generating a typeface from the scanned image. Such a method is advantageous because it may allow the machine generated typeface to be made to look like the typeface and/or font used in the original document.

In some embodiments, the method may comprise having a user input to the machine generating the document a predetermined number of examples of one or more characters. Generally, this would be a predetermined number of examples of each character. The user may make an input to the machine using any suitable input mechanism, but may include any of the following: a scanner; a tablet; a mouse; a light pen. These input means may provide a hand-writing reader and/or an acquiring means.

The shape of an example of a character may be varied on a random, pseudo random, according to a known method, or any other suitable basis. It will be appreciated that in hand written text the characters preceding and following any one character can affect how that character looks compared to other examples of that character written by the same person. Therefore, one possible method may be to vary the shape of a character according to the character that precedes and/or follows any one character.

It will also be appreciated that in any piece of hand written text there are generally imperfections that cause random variations between characters. Other methods may introduce such random variations to the shape of a character instead of and/or as well as other variations of the shape of a character.

According to a seventh aspect of the invention there is provided a machine-readable medium containing instructions which when loaded onto a computer cause that computer to perform the method of the first and/or second and/or third aspects of the invention.

According to an eighth aspect of the invention there is provided a machine-readable medium containing instructions which when loaded onto a computer cause that computer to function as the computer system according to the second and/or fourth aspects of the invention.

The machine readable medium of any of the seventh or eighth aspects of the invention may be any one or more of the following: a floppy disk; a CDROM/RAM; a DVD ROM/RAM (including +R/RW, −R/RW); any form of magneto optical disk; a hard drive; a memory; a transmitted signal (including an internet download, file transfer, or the like); a wire; or any other form of medium.

According to an ninth aspect of the invention there is provided a program arranged to cause a processing means to generate a document the text of which is intended to look like hand writing and to access a memory, the memory being arranged to store a font based upon a typeface, the font allowing a user to alter the appearance of the typeface and the type face being constituted by a plurality of characters, the program causing the processing means to access said memory and select an example of a character from the typeface as a character is required for the document and further arranged to cause the processing means to vary the shape of any one character between occurrences of at least some of that character.

### BRIEF DESCRIPTION OF THE DRAWINGS

There now follows by way of example only a detailed description of the present invention with reference to the accompanying drawings in which:

FIG. 1 shows an example of a prior art font;

FIG. 2 shows a computer system suitable for use in the present invention;

FIG. 3 provides an example of a portion of a font for use in an embodiment of the present invention;

FIG. 4 provides a second example of a portion of a set of fonts for use in an embodiment of the present invention;

FIG. 5 shows a scanner suitable for use with the present invention;

FIGS. 6a to g shows examples of how a character can be modified in an embodiment of the invention; and

FIG. 7 shows a flow chart outlining a method of an embodiment of the present invention.

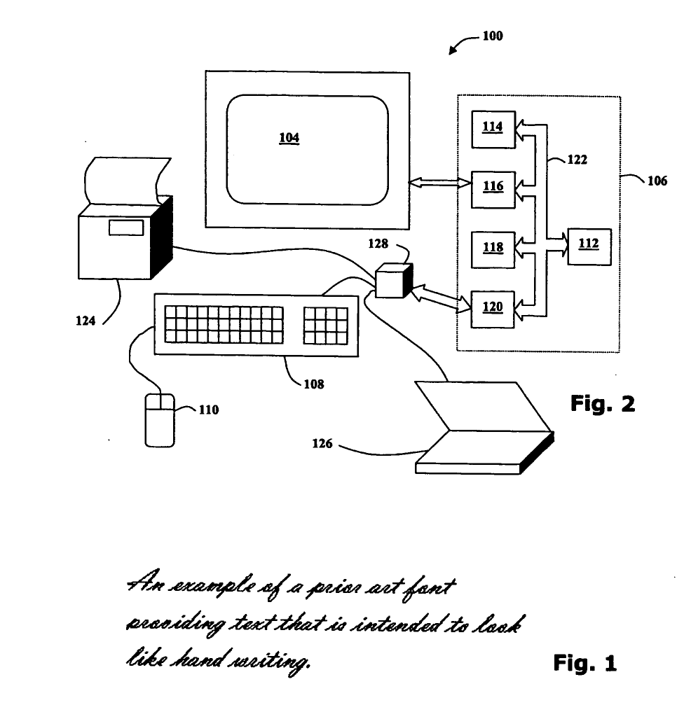

### DETAILED DESCRIPTION OF ILLUSTRATIVE EMBODIMENTS

It will be appreciated that the terms font and typeface are associated with text that has been prepared electronically. However, to clarify the use of these terms herein a typeface refers to a design for a set of characters and represents one aspect of a font. A font is a combination of typeface and other qualities such as size, pitch, spacing, whether bold, whether italic, and the like. Font and typeface are not synonymous and should be given their correct meaning.

In one embodiment the processing apparatus 100 comprises a display 104, processing circuitry 106, a keyboard 108, and mouse 110. The processing circuitry 106 further comprises a processing apparatus 112, a hard drive 114, a video driver 116, memory 118 (RAM and ROM) and an I/O subsystem 120 which all communicate with one another, as is known in the art, via a system bus 122. The processing means, or apparatus, 112 comprises an INTEL™ PENTIUM™ series processor, running at typically between 2 GHz and 2.5 GHz. Of course, other processors such as the AMD™ ATHLON™, POWERPC™, DIGITAL™ ALPHA™, processors are equally possible.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 is used as mass storage for programs and other data.

It will be appreciated that although reference is made to a memory 118 it is possible that the memory could be provided by a variety of devices. For example, the memory may be provided by a cache memory, a RAM memory, a local mass storage device such as the hard disk 118, any of these connected to the processing circuitry 106 over a network connection such as via the I/O subsystem 120. or similar devices. However, the processing apparatus 100 can access the memory via the system bus 122 to access program code to instruct it what steps to perform and also to access other data held in the memory such as typefaces and fonts. The processing apparatus 100 can then processes the data (such as the typeface and/or font) as outlined by the program code.

Other devices such as CDROMS, DVD ROMS, network cards, etc. could be coupled to the system bus 122 and allow for storage of data, communication with other computers over a network, etc.

The server 100 could have the architecture known as a PC, originally based on the IBM™ specification, but could equally have other architectures. The server may be an APPLE™, or may be a RISC system, and may run a variety of operating systems (perhaps HP-UX, LINUX, UNIX, MICROSOFT™ NT, AIX™, or the like).

In the embodiment being described, a laser printer 124 (for example an HP LASERJET 4050™) and a scanner 126 (for example an HP SCANJET™) are connected to the I/O subsystem via a USB hub 128 (to which the keyboard 108 also connects). The printer 124 may be thought of as a printing means and/or a reproduction means.

When the characters from a font are displayed next to one another within a document, it will be appreciated that there are a number of parameters relating to the characters which may be varied. Variations in these parameters affect how the characters of the font looks within the document. In the prior art the characters within the font are selected from a character set and the character set remains unchanged; i.e. if a bold typeface is selected within a font then although the font remains unchanged the character set used for the bold characters is different from the character set used for the characters that are not bold.

In order to generate a document the processing means 112 accesses the memory 118 and/or the hard drive 114 to access character sets forming the font that is being used to create a document by a program such as a word processing program, an email program, or the like. The program being used to create the document creates its own file which is held in the memory 118 and/or the hard drive 114 and contains details of the document being generated. As will be appreciated the file contains data that can be used to recreate the document at a later time and as such contains data that specifies the font and typeface to be used for each character. In some embodiments the processing means 112 needs both the file and the font and/or character set to be accessible thereto in order to recreate the document at a later time. In other embodiments, the processing means 112 may embed the font and/or typeface within the document at the time the document is created in order that the (or another) processing means may recreate the document at a later time without needing the font and/or typeface to be accessible by the processing means 112.

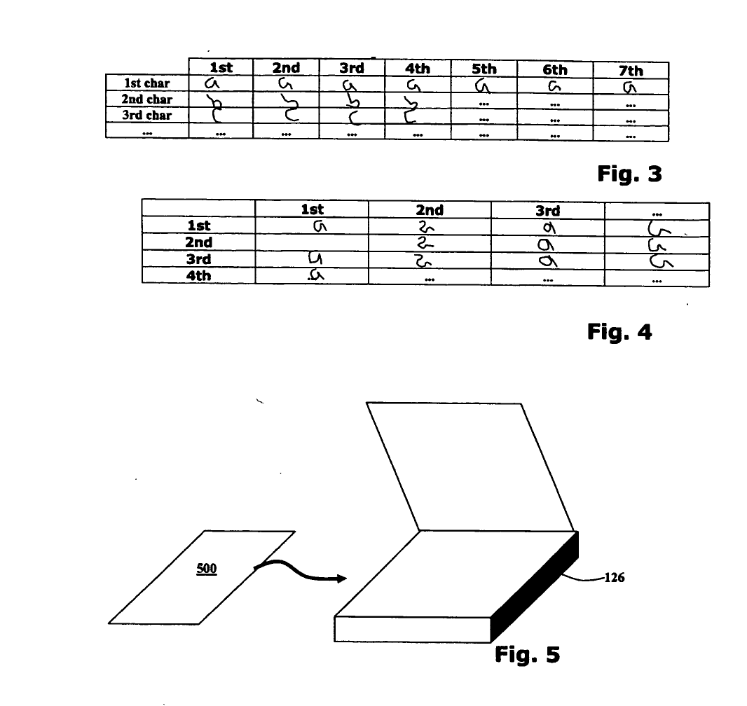

FIG. 3 shows an example of a character set providing seven different examples of a character within that character set which is used as will be described hereinafter. It should be noticed that each example of any one character within the character set (for example the character “a”) is slightly different from each of the other examples within the character set, providing seven slightly different characters. Likewise, each of the examples of each other character provides a slightly different version of that character (although, for the sake of brevity only some of the characters have been shown).

In perhaps the simplest embodiment described herein, when the processing apparatus is used to create a document using the characters outlined in FIG. 3 each time that a character is used in that document then the character selected for use in the document is randomly selected from the character set by the processing apparatus 112. Of course a selection process other than random (such as pseudo random, according to a predetermined pattern, etc.) may be used. Further, the font being used to display the character from the character set may further vary the look of the character (for example, the font may change the character size, the spacing, whether it is bold, or italic or the like). Thus, as it will be appreciated, since each version of a character within a character set (e.g. the first character “a”) is slightly different from each other example of that character within the character set then the document may take on a less uniform appearance and may look more like hand written text when compared to the prior art.

It will of course be appreciated that a document need not be paper, or similar media, based, and may be an electronic document. The use of electronic documents is becoming increasingly common and the variety of such documents is becoming increasingly varied. Such electronic documents includes, but is not intended to be limited to, web pages, word processed documents, platform independent formats such as Adobe™ Acrobat™, SMS text messages, spreadsheets, databases, e-mails, or the like. Embodiments of the invention outlined herein are equally applicable to printed and electronic documents.

In other embodiments the process that is used to determine which example of a character should be selected may not simply be random and may be influenced by other parameters. For example, the character preceding and/or following the character may influence the character selection. Some versions of a character may be tailored to that they can be followed by a letter having an ascender and/or descender and/or any other specific portion of a character. Indeed, any other suitable process may be used. It may also be possible for characters to be varied on what may be thought of as a macro-scale. For example for some people, as they write faster, their handwriting gets “sloppier”, or “leans” more/less, or gets taller/squatter. The methods described herein may be used such that a document generated by the method reflects these macro-scale variations. Such a macro-scale variation may be controlled by a parameter such as a document parameter which may be varied for a document, which may be constant for the document or may alternatively vary in some way over the document. For example introducing variations in the typeface document parameter(s) indicative of the person writing the document being in a rush or becoming more rushed as the document progresses.

Prior art word processing programs have allowed a user to vary the font that he/she is using. Such font variations are generally reflected by tags in the file that is created by the word processing method. For example the phrase: “I know you” may be represented as follows: <font1>I□<italic>know□</italic>you</font1>. The square symbol is intended to represent a space.

The tags within pairs of brackets i.e. <> provide an indication of the font that should be used for the following characters. An opening bracket followed by a “/” indicates the end of a particular font. Therefore, the tag </italic> may represent an end to the portion of text that is to be shown as italic.

The methods so far described may be incorporated into known word processing packages by utilising the tags used by a particular word processing package to provide an indication of which example of a character from a character set is to be used for each character that is provided in the document. As such it should be possible to cause known word processing packages, spreadsheets, databases, etc. to utilise embodiments of the invention as described herein.

As an example, a portion of the same phrase “I know you” may be represented as follows using this technique: <f1>I<f2>□<f3>k<f4>n<f5>o<f6>w . . . . Thus, in one embodiment, a word processing package may use a font which uses the character set containing a plurality of examples of each character as described in relation to FIG. 3. A macro, or other suitable mechanism, may be used to randomly, or otherwise, alter the example of a character the characters within the document being generated. Indeed, the methods described herein may be applied as the user is creating the document, or may be used to process the document once it has been created: i.e. the method may be real time, or applied to existing text.

FIG. 4 shows a further embodiment of the invention which provides a plurality of character sets (with a character setshown in a column) with each character set comprising a number of examples of each character of the character sets. For convenience only the first character of each character set has been shown and an example of each character is shown per row of the table. Each example of a character within the same character set has at least one common trait with the other examples of that character within the character set, but which common trait may vary between character sets. Thus, it will be appreciated that a user may be able to select a character set or indeed font that reflects the style of writing that he/she wishes to use.

Indeed, in some embodiments character sets may be created from a sample of a users hand writing. One example of a suitable mechanism that may be used to enter a sample of the user's hand writing to a computer system 100 is a scanner 126. Other suitable input mechanisms may include any of the following (although this is not intended to be exhaustive): a mouse; a graphics tablet; a roller-ball; a light pen; a touch screen; or the like. If a scanner is used then a user may write a predetermined phrase on to a sheet 500 to be scanned by the scanner 126. The text on the sheet 500 is then scanned on to the computer system 100 and processed by the processing apparatus 112.

In one embodiment the processing apparatus 112 may simply identify, have identified thereto, etc., characters within the text and then generate an example character for the character set from the image of the identified character. As such the processing apparatus 112 is providing a typeface creation means and/or a font generation means. The process of generating the character set from the user's hand writing may be an interactive process allowing a user to alter the character set.

In other embodiments, the processing apparatus 112 may be arranged to identify a plurality of examples of the same character (for example the letter “a”) and subsequently to identify common traits between those examples. Once the traits have been identified it may be possible for the processing apparatus 112 to generate further examples of that character which also follow the traits identified within the identified characters.

Various mechanisms including the use of vectorisation and statistical modelling, or the like, may be used in order to generate characters having the identified traits. Should such a mechanism be used it may not be necessary to maintain examples of the characters for selection (although it is of course still a possibility) and characters may be generated as required.

Vectorisation will generally replace a set of pixels with a set of vectors, so that variations in the vectors are used as a method of creating the set of characters to produce a character set. This may be achieved for one or more characters in the character set, by scanning and vectorising a number of different examples of each such character, and then applying statistical analysis such as Principal Components Analysis (PCA) or Non-Linear Principal Component Analysis (NLPCA) so that a statistical model of how the character appears in the font is created. Once the statistical model has been formed it is then used to create new instances of the character that are recognisably similar to the examples, but not necessarily the same as any of the examples used to form the model. PCA and NLPCA are well known in prior art and have been used for a number of statistical model-building applications.

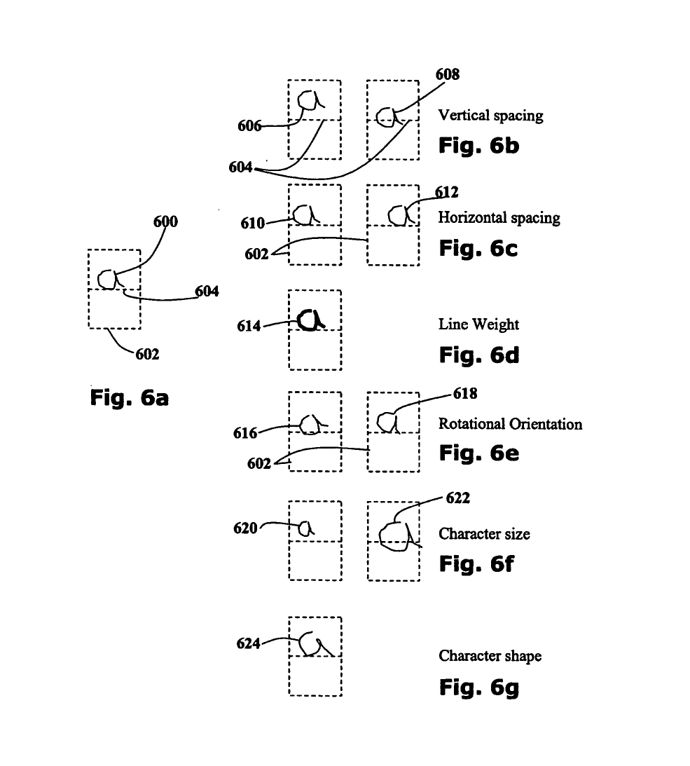

FIG. 6 summaries mechanisms that the processing apparatus 112 can use in order to vary a parameter of any one character between at least some occurrences of that character to vary the look between characters.

An example character 600 (an “a”) is shown within a grid 602 commonly used to display characters so that various parameters of the character are clearer. Of note, within the grid 602, is the base line 604 upon which the character would usually sit such that any descender is below the base line 604.

FIG. 6b shows an example in which the position of the character 606 has been raised relative to the base line 604 and the character 608 has been lowered relative to the base line 604 when compared to the character 600 in FIG. 6a.

FIG. 6c shows an example in which the position of the character 610 has been moved left relative to the grid 602 and the character 612 has been moved right relative to the grid 602 when compared to the character 600 in FIG. 6a.

FIG. 6d shows an example in which the weight of line of the character 614 has been increased when compared to the character 600 in FIG. 6a. It would of course also be possible to decrease the weight of the character.

FIG. 6e shows an example in which the character 616 has been rotated anti-clockwise relative to the grid 602 and the character 618 has been rotated clockwise relative to the grid 602 when compared to the character 600 in FIG. 6a.

FIG. 6f shows an example in which the size of the character 620 has been decreased when compared to the character 600 in FIG. 6a and the size of the character 622 has been increased when compared to the character 600.

FIG. 6g shows an example in which the shape of the character 624 has been changed when compared to the character 600 in FIG. 6a.

It is possible for the processing apparatus 112 to employ any one or more of the techniques described in relation to FIGS. 6a to g and some embodiments may apply a plurality of the techniques to any one occurrence of a character. Indeed, there may be other techniques that allow the appearance of a character to be altered that are not mentioned herein.

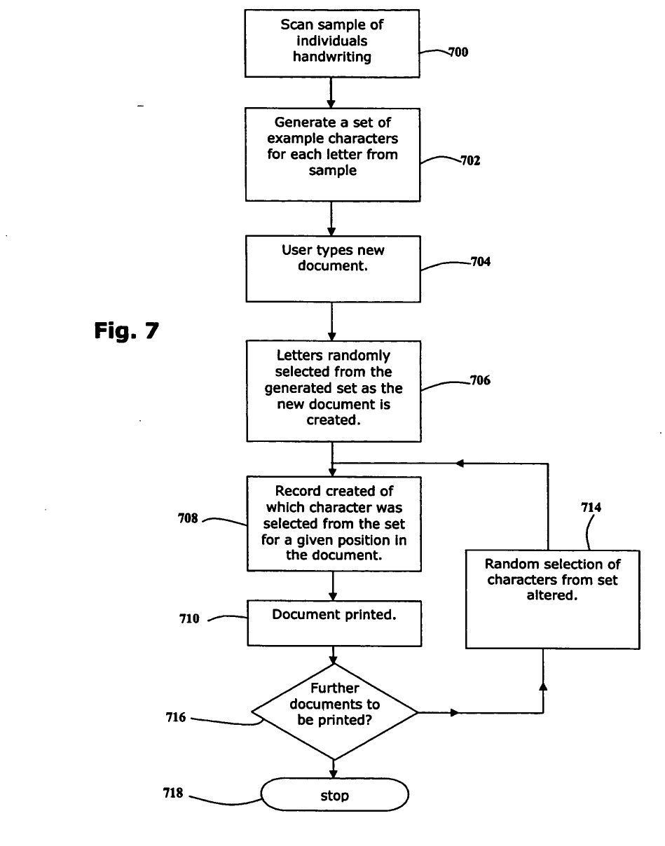

FIG. 7 outlines a process that may be used in one embodiment of the invention. The process is aimed at providing a secure document and starts with a scan of an individual's hand writing being made 700. As described above, the processing apparatus 112 processes the scan and generates 702 a character set from characters that have been recognised within the scan with the character set comprising a plurality of examples of each character. The user may provide a predetermined piece of text such that the characters used to make the characters may be easier to recognise.

Once the character set has been generated by the processing apparatus 112 it is stored within the hard drive 114 (or other storage means or memory accessible by the processing apparatus 112) for future use. Then, a user can type a document 704 using the character set such that a parameter of a character is varied 706 between occurrences of at least some of the characters. In perhaps the most preferred embodiment, the shape of the character is varied between at least some of the occurrences of a character.

As the document is generated a record is made of the, or each, parameter associated with each of the characters in the document 708. Once the document is finished it can be reproduced by a reproduction means which includes being printed 710, although this is not necessary and the document may be maintained in electronic form. It would of course be possible to generate physical representations of the document by other means that printing and any suitable means could be controlled to generate a physical representation of the document. For example, it may be possible to generate engraved/carved/woven, or the like versions of the document.

If further documents are to be printed, or otherwise generated in physical form, then 716 then it would be possible to slightly alter the parameters associated with one or more characters within the document 714 to provide a unique “finger print” for each document that is printed. In some embodiments, the same finger print may be applied to the same document printed by the same user, but the finger print may be changed if a user login is changed, the document is printed from a different computer system 100. Indeed, if further copies of the document in electronic form are to be created then it is possible that each version of the electronic document could have a finger print generated.

An example of how a finger print is created follows: when a document is generated, an identifying code-number for the owner of the document, and an identifying code-number for the machine that the document is created on, are combined with a numeric representation of the date and time at which the document is generated (it being assumed that the time is represented with sufficient accuracy that each document has a unique creation-time). This set of numeric code and date/time data is then used to form the “seed” number for an appropriate pseudo-random-number generation algorithm, thereby determining the precise sequence of font-changing instructions that will determine the “fingerprint” for the document. To recover a document's fingerprint, each character in the document is analysed to determine from which character it came, thereby establishing the sequence of character-change instructions that is the fingerprint. The character-change sequence could then be compared to a database of such fingerprints to establish the original/intended ownership of that document.

1. A method of machine generating a document containing one or more characters which are intended to look like hand writing comprising providing a handwriting acquiring means arranged to acquire, in machine readable format, a portion of a person's hand writing, providing an analysis means arranged to analyse the portion, and a typeface generation means arranged to generate a typeface constituted by one or more characters, the method further comprising acquiring a portion with the handwriting acquiring means and analysing the portion with the analysis means, in order to identify traits within characters of that hand writing, and using the identified traits to generate a typeface with the typeface generation means constituted by a one or more characters for said machine generated document.

2. A method according to claim 1 in which the characters are generated using at least one or more of the following: variation of a bit map; vectorisation and variation of vectors.

3. A method according to claim 1 in which characters are generated using a statistical model.

4. A method according to claim 1 in which the method comprises generating a plurality of examples of each character and selecting characters from the examples in order to provide a character.

5. A method according to claim 1 in which the method comprises at least one of: altering the shape of at least one example of a character; generating an example of a character each time an example of a character is required.

6. A method according to claim 1 in which the handwriting acquiring means comprises a scanner which is used to scan a hand written document to acquire the portion of a person's handwriting.

7. A method according to claim 1 in which the shape of any one character from the typeface is varied on one of the following bases; random; pseudo random; deterministic.

8. A method according to claim 1 in which the shape of any one character from the typeface is varied according to at least one of the following: the character that precedes that character within the document; the character that follows that character within the document.

9. A method according to claim 1 in which a document parameter associated with the document can be altered in order to alter the appearance of at least some of the characters generated by the method.

10. A method according to claim 9 in which the document parameter is varied within any one document.

11. A method according to claim 1 in which the shape of a character is varied by altering at least one of the following: the dimensions of any one example of a character relative to other examples of that character; the position of character relative to other examples of that character; the shape of the character; the width of the line used to represent the character; the rotational orientation of the character; variations in the relative spacing and arrangement and dimensions of components (e.g. strokes/vectors) of the characters; the partial or complete absence of such components, such that variations are consistent with a statistical model of the font that has been constructed.

12. A computer system comprising a processing means, said processing means being programmed to generate a document the text of which is intended to look like handwriting, said processing means comprising a handwriting acquiring means, arranged to acquire a portion of a persons handwriting, an analysis means arranged to receive and analyse said portion in order to identify traits within characters of the handwriting, and a typeface generation means arranged to use the identified traits to generate a typeface, the typeface being constituted by a plurality of characters.

13. A computer system according to claim 12 which further comprises a memory, the memory and a character variation means arranged to vary a characteristic of the character being arranged to store a font based upon the typeface, the processing means being further arranged to access said memory and select an example of a character from the typeface as a character is used for the document and further arranged to use the character variation means to vary the shape of any one character between at least some occurrences of that character.

14. A computer system according to claim 13 in which the character variation means of the processing means is arranged to vary the shape of a character by altering one or more of the following: the dimensions of any one example of a character relative to other examples of that character; the position of character relative to other examples of that character; the shape of the character; the width of the line used to represent the character; the rotational orientation of the character; variations in the relative spacing and arrangement and dimensions of components (e.g. strokes/vectors) of the characters; the partial or complete absence of such components, such that variations are consistent with a statistical model of the font that has been constructed.

15. A computer system according to claim 12 which further comprises a memory arranged to store a plurality of examples of each character and in which the processing means is capable of accessing the memory and is arranged to select a character from the examples in order to provide a character.

16. A computer system according to claim 12 in which the processing means is arranged to alter the shape of one or more examples of a character and/or generate an example of a character each time that example of a character is required.

17. A method of increasing the security of a document comprising providing a document generation means arranged to generate a document comprising a plurality of characters, generating the document such that at least one character used therein has the shape thereof varied when compared to at least one other occurrence of that character elsewhere in the document, the method further comprising providing a recording means and recording the variation of the shape of the or each character in the recording means such that the identity of the document can be verified using the recorded variation of the shape of the or each character.

18. A method according to claim 17 in which a memory containing a plurality of predetermined examples from a typeface comprising a plurality of examples of the or each character therein is provided and in which the shape of a character is selected from the memory.

19. A method according to claim 17 in which a processing apparatus arranged to generate characters is provided and in which the shape of a character is generated by the processing apparatus.

20. A method according to claim 17 which comprises providing a printing means and in which generation of the document comprises printing the document.

21. A method according to claim 17 which includes the step of varying the shape of at least one character in situations including any of the following: each time the document is generated; for each person that generates the document; for each printer/computer from which the document is generated; for each intended and/or actual recipient of the document.

22. A computer system comprising a processing means, a storage means capable of allowing the processing means to store data therein and a reproduction means connected to and controllable by said processing means said processing means being programmed to cause said reproduction means to reproduce a document using characters, such that at least one character used therein has the shape thereof varied when compared to at least one other occurrence of that character elsewhere in the document, and being further programmed to record data within the storage means recording the variation of the shape of the or each character such that the identity of the document can be verified using the recorded variation of the shape of the or each character.

23. A machine-readable medium containing instructions which when loaded onto a computer cause that computer to perform the method of claim 1.

24. A machine-readable medium containing instructions which when loaded onto a computer cause that computer to perform the method of claim 17.

25. A machine-readable medium containing instructions which when loaded onto a computer cause that computer to function as the computer system according to claim 12.

26. A machine-readable medium containing instructions which when loaded onto a computer cause that computer to function as the computer system according to claim 22.

27. A method of machine generating a document containing one or more characters which are intended to look like hand writing comprising providing a handwriting reader means arranged to read a portion of a person's hand writing and convert it in machine readable format, providing an analyser to analyse the portion, and a typeface generator arranged to generate a typeface constituted by one or more characters, the method further comprising reading a portion, with the handwriting reader means and analysing the portion format with the analyser, in order to identify traits within characters of that hand writing, and using the identified traits to generate a typeface with the typeface generation means constituted by a one or more characters for said machine generator document.

28. A computer system comprising a processor arranged to generate a document the text of which is intended to look like handwriting, said processor comprising a handwriting reader, arranged to read a portion of a persons handwriting and convert the portion into a machine readable format, an analyser arranged to receive and analyse said machine readable portion in order to identify traits within characters of the handwriting, and a typeface generator arranged to use the identified traits to generate a typeface, the typeface being constituted by a plurality of characters.

29. A computer system comprising a processor, a memory capable of allowing the processor to store data therein and a printer connected to and controllable by said processor, said processor means being programmed to cause said printer to print a document using characters, such that at least one character used therein has the shape thereof varied when compared to at least one other occurrence of that character elsewhere in the document, and being further programmed to record data within the memory recording the variation of the shape of the or each character such that the identity of the document can be verified using the recorded variation of the shape of the or each character.

30. A method of increasing the security of a document comprising providing a document generator arranged to generate a document comprising a plurality of characters, generating the document such that at least one character used therein has the shape thereof varied when compared to at least one other occurrence of that character elsewhere in the document, the method further comprising providing a memory arranged to store data and storing the variation of the shape of the or each character in the memory in the recording means such that the identity of the document can be verified using the stored variation of the shape of the or each character.

31. A method of machine generating a document containing one or more characters which are intended to look like hand writing comprising providing a handwriting acquiring means arranged to acquire, in machine readable format, a portion of a person's hand writing, providing an analysis means arranged to analyse the portion, and a typeface generation means arranged to generate a typeface constituted by one or more characters, the method further comprising acquiring a portion with the handwriting acquiring means and analysing the portion with the analysis means, in order to identify traits within characters of that hand writing, and using the identified traits to generate a typeface, with the typeface generation means, constituted by a one or more characters for said machine generated document wherein the shape of any one character from the typeface is varied according to at least one of the following: the character that precedes that character within the document; the character that follows that character within the document.
